(19) United States
(12) Patent Application Publication
(10) Pub. No.: US 2008/0241306 A1
(43) Pub. Date: Oct. 2, 2008

(54) Heat transfer imprinting machine with improved frame construction

(76) Inventors: Duke W. Goss, Kirkland, WA (US); David Littrell, Mukilteo, WA (US)

Correspondence Address: BARNARD INTELLECTUAL PROPERTY LAW, INC., P.O. BOX 58888, SEATTLE, WA, 98138-1888, US

(21) Appl. No.: 11/643,306

(22) Filed: Dec. 21, 2006

(51) Int. Cl. B29C 59/02

(52) U.S. Cl. 425/385

(57) ABSTRACT

A frame (10) has an arch that is composed of a top portion (12) and side portions (16) extending downwardly from the opposite ends of the top portion (12). The bottoms of the side portions (16, 18) are connected to outer end portions of a transverse frame member that is a part of a base for the frame. The base also includes a pair of longitudinal frame members which are spaced apart from each other and are spaced inwardly from the side portions (16, 18) of the arch (12). These longitudinal frame members also form tracks for a carriage that supports a lower platen. The platen and carriage are slideable between “in” and “out” positions much like a drawer is slid in and out.

### TECHNICAL FIELD

This invention relates to a heat transfer imprinting machine having a heated upper platen movable towards and away from a lower platen. More particularly, it relates to the provision of such a machine having a frame that includes an arch that extends over the platens from one side of the machine to the other, wherein the upper platen is supported from an upper central portion of the arch.

### BACKGROUND OF THE INVENTION

It is well known to apply text and/or artwork onto shirts, towels, hats, visors, and other articles (“work piece”), by use of a heat transfer process. Thermal-set material forming the text and/or artwork is applied to one side of a flat planar sheet, forming what is termed a “transfer.” Typically, the work piece is positioned on the lower platen of a press, or on a work-piece support positioned above the lower platen. The transfer is then set down on the work-piece with its thermal-set material in contact with the work-piece. Then, a heated upper platen is lowered onto the transfer and pressure and heat are applied to the transfer. The combination of heat and pressure causes adhesion of the transfer to the work-piece. Known heat transfer machines are disclosed by pending application Ser. No. 10/790,433, filed Feb. 27, 2004, and entitled Heat Imprinting Machine With Separate Work Piece Support, and by pending application Ser. No. 11/378,156, filed Mar. 17, 2006, and also entitled Heat Imprinting Machine With Separate Work Piece Support.

The machines shown by application Ser. Nos. 10/790,433 and 11/378,156 have a frame structure that includes a base, a support post extending upwardly from one end of the base, and a support arm extending from the post over the base. The lower platen is supported by the base. The upper platen is supported by the support arm. Specifically, the upper platen is positioned below a free end of the support arm which is spaced from the post. The machine includes a mechanism for moving the upper platen up and down relative to the lower platen. When this mechanism is operated, it moves the upper platen towards and away from the free end of the support arm. The support arm is a cantilever beam supported by the post. Operation of the press imposes bending movements on the support arm, stressing the connection between the support arm and the post. When the support arm and the rest of the frame are constructed to withstand the forces that are imposed by operation of the press, the resulting frame is large and the entire machine is heavy.

There is a need to simplify the frame in a way that makes the frame stronger and at the same time smaller and lighter in weight. The primary object of the present invention is to fulfill this need.

### BRIEF SUMMARY OF THE INVENTION

The heat transfer imprinting machine of the invention comprises a base having spaced apart opposite sides. A lower platen is supported on and by the base. A support arch is provided having a top portion and opposite side portions which depend from opposite side boundaries of the top portion, down to lower ends which are connected to the opposite sides of the base. An upper platen is positioned vertically between the lower platen and the upper portion of the arch. A vertically movable push/pull member extends downwardly from a central part of the top portion of the arch. The push/pull member has a lower end that is attached to the upper platen. The push/pull member is movable vertically up and down to move the upper platen towards and away from the lower platen.

Preferably, the heat transfer imprinting machine of the invention comprises a housing at the center of the top portion of the support arch and the push/pull member extends downwardly from said housing to a connection with the upper platen.

The heat transfer imprinting machine of the invention may comprise a lever extending from the housing and movable between up and down positions for moving the push/pull member and the upper platen up and down.

In preferred form, the base includes base members that are laterally spaced apart from each other and are spaced laterally inwardly from the side portions of the arch. These base members engage the lower platen and support it for horizontal sliding movement between a position substantially below the upper platen and a position at least partially endwise of the upper platen.

The base includes a cross-frame member that extends from one lower end of the arch over to the other lower end of the arch, and at least one longitudinal frame member that extends across and is connected to the cross-frame member. In preferred form, the base includes two longitudinal frame members which are spaced laterally apart and each extends across and is connected to the cross-frame member.

The top and side portions of the arch may at least in part have a channel cross-sectional shape that extends downwardly from the top portion and laterally inwardly from the side portions. The top and side portions of the arch may also include at least one strengthening rib that is between the side flanges and projects from the web in the same direction as the side flanges. In preferred form, the top and side portions of the arch each have two strengthening ribs which are spaced apart from each other and are spaced laterally inwardly from the side flanges of the arch.

Preferably, telescopic members are provided having fixed portions that are connected to the two longitudinal frame members of the base and movable portions which are connected to the lower platen. The movable portions are telescopically mounted on the fixed portions and are movable between retracted and extended positions. When the movable portions are retracted, the lower platen is substantially vertically below the upper platen. When the movable portions are extended, they are supported in the fashion of cantilever beams out from the fixed portions and support the lower platen in a position spaced outwardly from under the upper platen.

Other objects, advantages and features of the invention will become apparent from the description of the illustrated embodiment that is set forth below, from the drawings, from the claims and from the principles that are embodied in the specific structures that are illustrated and described.

### BRIEF DESCRIPTION OF THE SEVERAL VIEWS OF THE DRAWINGS

Like reference numerals are used to designate like parts throughout the several views of the drawing, and:

FIG. 1 is a pictorial view of a heat transfer imprinting machine that is constructed according to the present invention, such view being taken from above and looking towards the top, one end and one side of the machine, such view showing an upper platen spaced upwardly from a lower platen, and showing a control lever from moving the upper platen in a first position;

FIG. 2 is a view like FIG. 1, but showing the lower platen move outwardly from below the upper platen into a position that is endwise of its position below the upper platen;

FIG. 3 is a pictorial view taken from below and looking towards the bottom, one side and one end of the machine, such view showing the lower platen in a position below the upper platen;

FIG. 4 is a view like FIG. 3, but showing the lower platen slid endwise outwardly from below the upper platen;

FIG. 5 is an end view of the heat printing machine shown by FIGS. 1-4, such view showing the machine in the position of FIG. 1;

FIG. 6 is a view like FIG. 5, but showing the control lever swung downwardly so as to move the upper platen downwardly towards the lower platen;

FIG. 7 is a side view of the machine shown by FIGS. 1-6, including a solid line showing of the lower platen below the upper platen and a broken line showing of the lower platen slid endwise outwardly from its position below the upper platen;

FIG. 8 is a pictorial view of a support arch portion of the machine frame, taken from above and looking towards the top, one end and one side of the arch;

FIG. 9 is a pictorial view of the support arch, taken from below and looking towards the bottom, one end and one side of the arch;

FIG. 10 is a pictorial view of the frame base, such view being taken from above and looking downwardly towards the top, one end and one side of the base; and

FIG. 11 is a sectional view through the slide mount on one side of the machine.

### DETAILED DESCRIPTION OF THE ILLUSTRATED EMBODIMENT

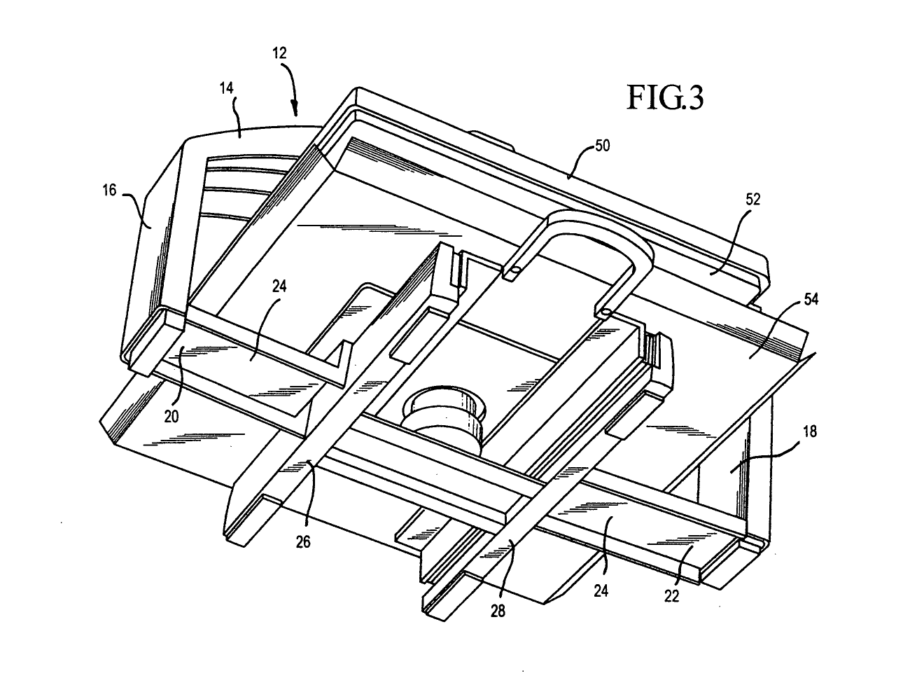

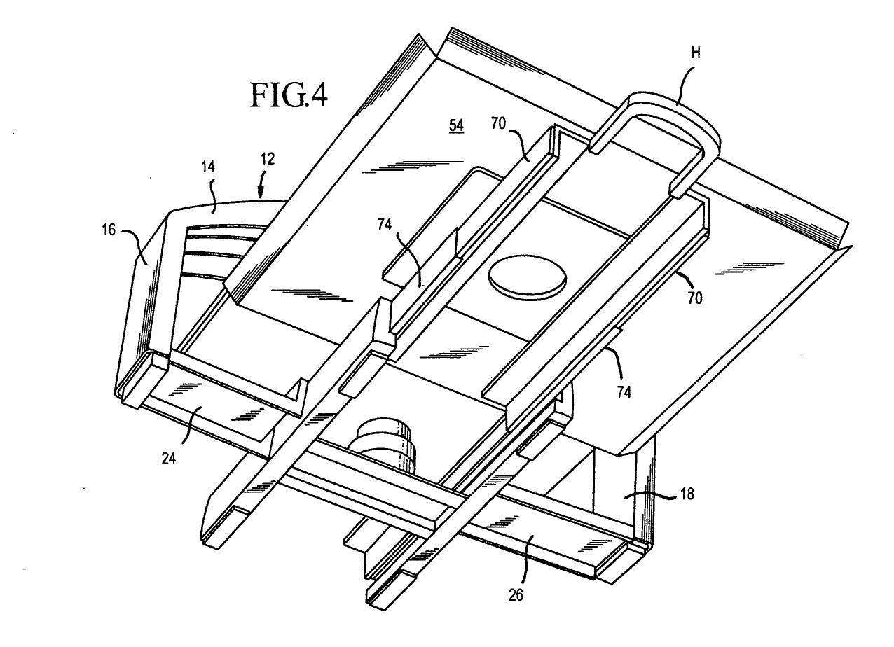

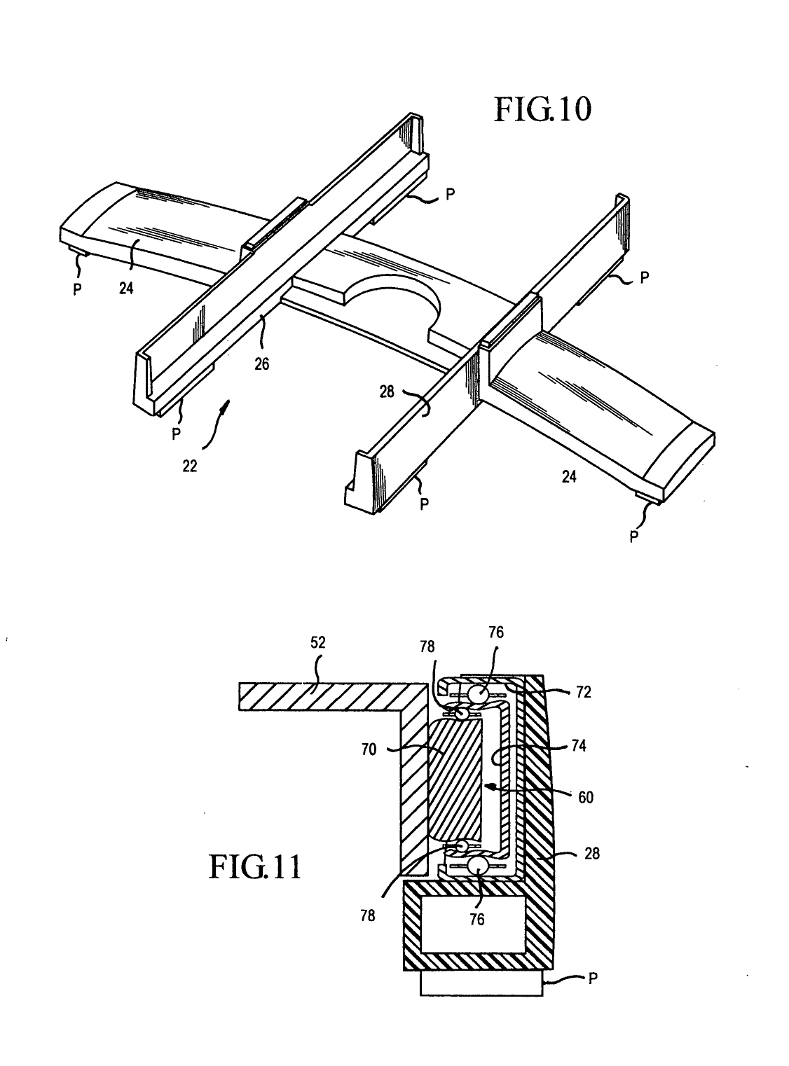

The illustrated embodiment comprises a support frame 10 having a support arch 12 that includes a top portion 14 and a pair of side portions 16, 18. The side portions 16, 18 may be straight and at their lower ends may connect to opposite end portions 20, 22 of a transverse frame member 24. The ends of the transverse frame member form side boundaries for the base of the frame. As best shown by FIGS. 3 and 10, the base of the frame includes a pair of longitudinal frame members 26, 28 that extend across and are connected to the transverse frame member 24. The longitudinal frame members 26, 28 are spaced apart from each other and are positioned inwardly of the ends 20, 22 of the transverse frame member 24. The transverse and longitudinal frame members 24, 26, 28 together give the base the shape of a H. This shape provides substantial stability together with a small size and a substantial reduction in weight.

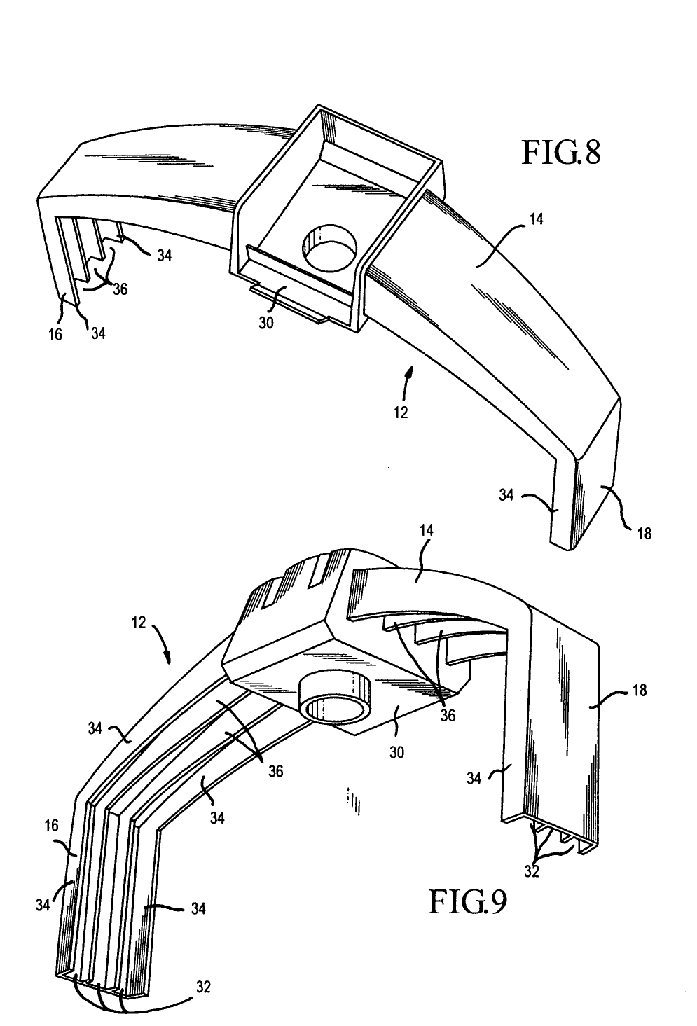

Referring to FIGS. 8 and 9, the arch 12 includes a housing base 30 at the center of the top portion of the arch 12. The rest of the top portion 14 of the arch 12 and the side portions 16, 18 of the arch 12 may have a channel shape, with the top portion opening downwardly and the side portions opening inwardly. This shape is formed by webs 32 and flanges 34. The arch 12 may also be reinforced by ribs 36 that are between the flanges, are spaced apart from each other and are spaced inwardly from the flanges. This construction is strong while at the same time being relatively light weight.

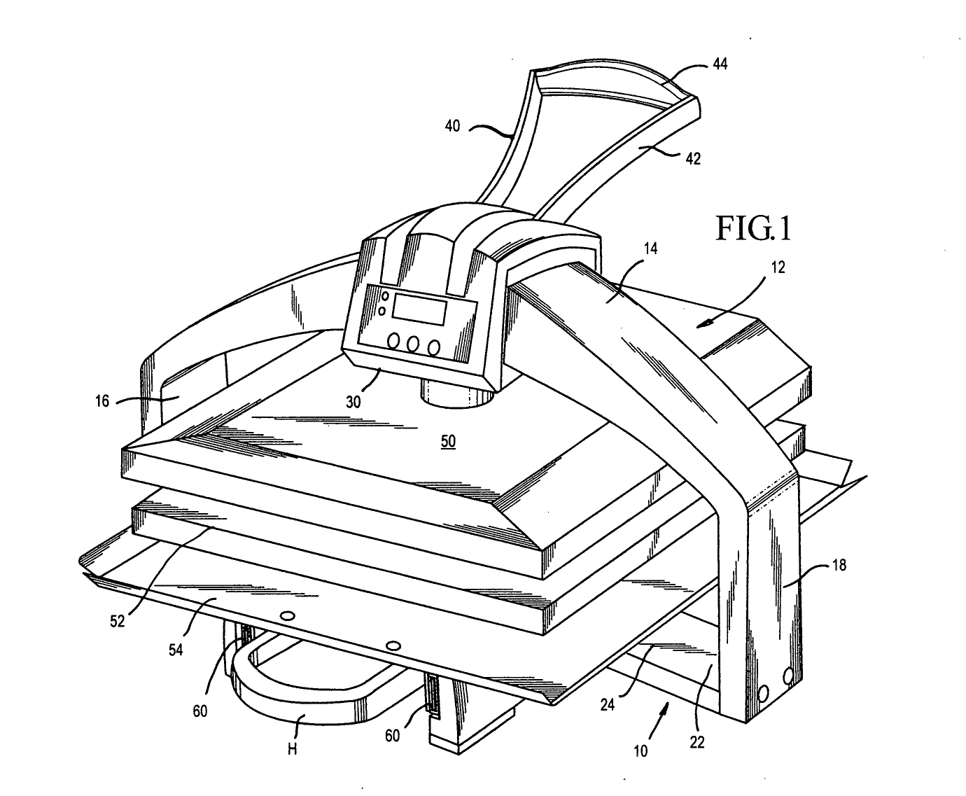

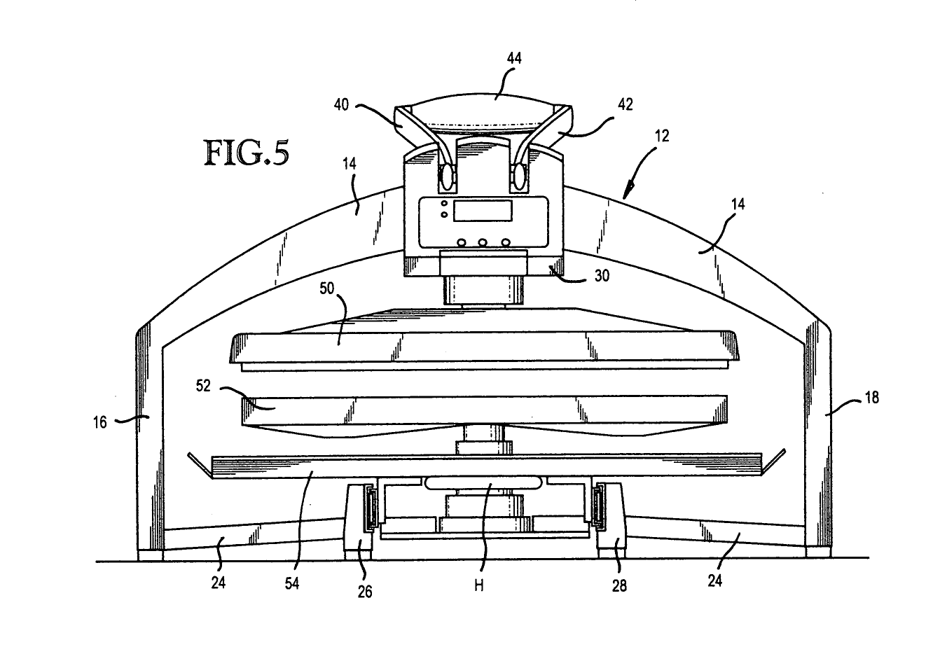

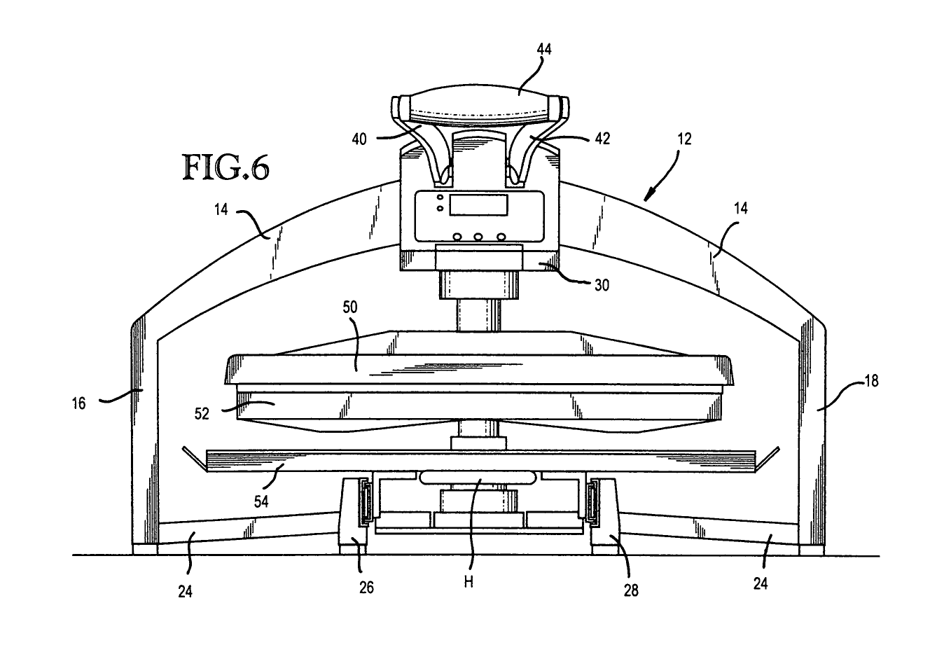

In this embodiment, the base 30 of the control housing has a bottom space below the top portion of the arch and end walls which together with the bottom provide a strong hub for the arch 12. When the upper portion of the housing is connected to the base portion of the housing (FIG. 1), the housing 30 is centrally located on the arch 12. A lever mechanism that may be similar to the lever mechanism disclosed by co-pending application Ser. No. 11/378,156 is within the housing 30. A control lever for this mechanism has side arms 40, 42 that are pivotally connected at their lower ends to side portions of the housing, and a handle 44 that extends between and is connected to the upper ends of the arms 40, 42. This handle has an “up” position, shown by FIGS. 1, 2, 5 and 7, and a “down” position shown by FIG. 6. When the lever is “up”, the upper platen 50 is moved upwardly into a position above the lower platen 52. When the lever 40, 42, 44 is “down”, the upper platen 50 is moved downwardly against a transfer and a work piece that are supported by the lower platen 52. When the upper platen 50 is “down”, it exerts a pressure on the transfer and work piece and also delivers heat to the transfer, causing the text and/or design that is on the transfer to be transferred to the work piece, e.g. a shirt. The force on the upper platen 50 is reacted by the arch 12 and is transferred by the arch 12 to the side portions 26, 28 of the base. This force extends substantially straight down through the center of the top portion 30 of the arch and so the arch members 14, 16, 18 can be relatively small in size. This is in contrast to the cantilever support that requires a substantial frame that is both bulky and heavy.

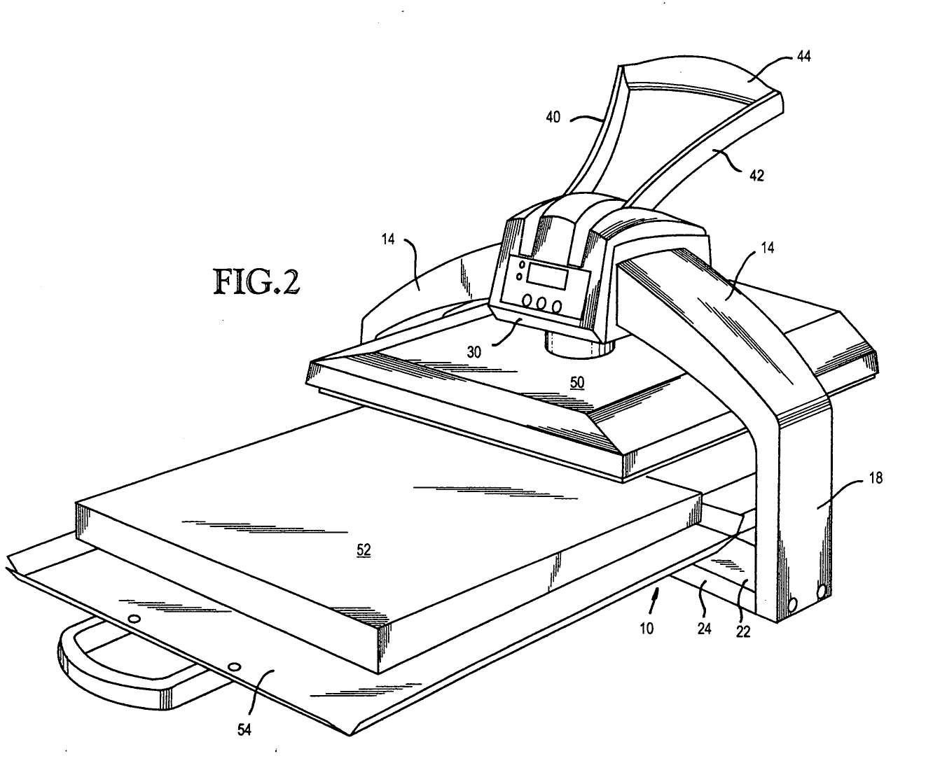

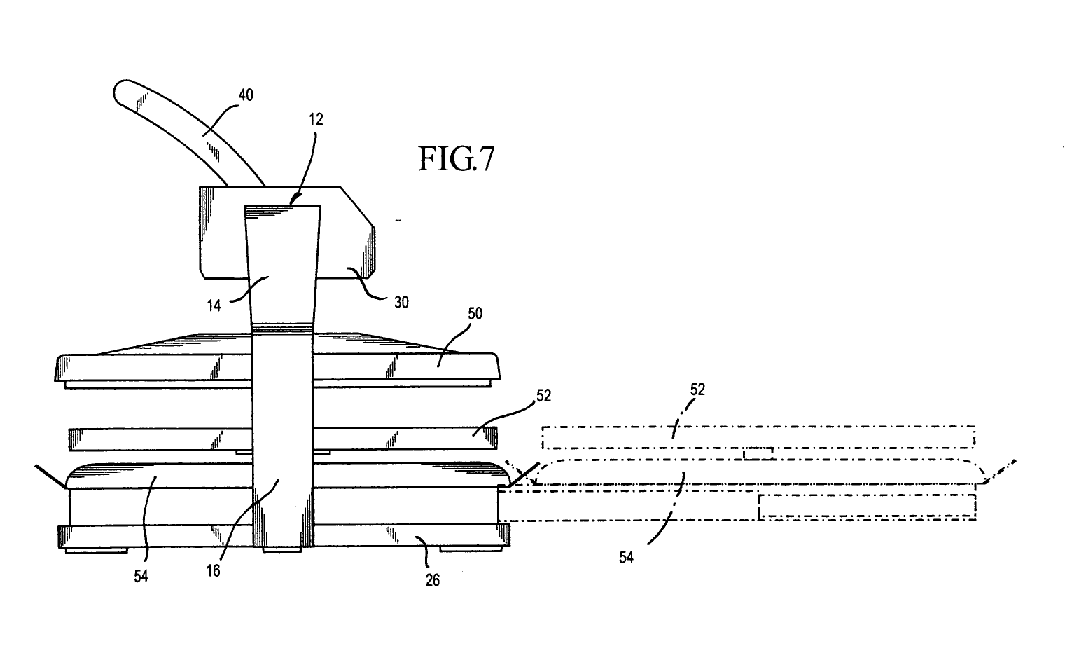

According to an aspect of the invention, the lower platen 52 is mounted in a way that permits it to be slid horizontally into and out from a position below the upper platen 50. The “in” position is shown by FIG. 1 and the “out” position is shown by FIG. 2. The longitudinal frame members 26, 28 of the base form tracks on which a carriage 54 is mounted for sliding movement between the “in” and “out” positions. The carriage 54 is like a drawer and the lower platen 52 is connected to the carriage 54. The slide mechanism may be like the slide mechanisms used with cabinet and desk drawers, for example. They need to be extendable/retractable and when extended be able to support the lower platen 52 in the positions shown by FIGS. 2 and 7.

The outer ends of members 24, 26, 28 are provided with pads P that sit on the support surface for the heat transfer imprinting machine. Pads P may be made from a soft material so that they will not mar the surface on which they are placed. The bottoms of the pads P are in a common plane so that the machine will be supported at all six pad locations.

As shown by FIG. 11, the carriage 52 is like a drawer and it includes drawer slide structure 60 on each of its sides. A handle H may be provided. This enables the user to grasp the handle H and either pull it and the carriage 15 towards his/her or push it to move the carriage away from him/her. As shown in FIG. 11, the drawer slide structure 60 has a first portion 70 that is attached to the carriage, a second portion 72 that is attached to the frame members 26, 28 and a third portion 74 that is between the portions 70, 72. Portion 70 is connected to and moves with the carriage 52. Portion 72 is fixed and is connected to the frame members 26, 28. Portion 74 is movable relative to both portions 70 and portion 72. Bearing 76 are between portions 72, 74 and bearings 78 are between portions 70, 74. When the carriage 52 is moved outwardly, portion 74 will move relative to portion 72 and portion 70 will move relative to portion 74. Thus, as best described, the structures 70, 72, 74 is a telescopic structure. It is a telescopic cantilever beam that supports the carriage 52 from the frame members 26, 28 when the carriage 52 is pulled outwardly from below the upper platen 50. Stop structures are provided to limit the extent of travel of portion 74 relative to portion 72 and portion 70 relative to portion 74. A standard drawer slide mechanism 70, 72, 74, 76, 78 has been described. However, the support mechanism for the carriage 52 can be any mechanism that will mount the carriage 52 for horizontal sliding movement between a position below the upper platen 50 and a position outwardly from below and spaced endwise from the upper platen 50. Accordingly, in use, the carriage 54 and lower platen 52 can be pulled outwardly from below the upper platen 50 and the work piece can be placed on the lower platen and the transfer placed on the work piece. Then, the carriage 54 and lower platen 52 can be slid inwardly to place them below the upper platen 50. As earlier stated, the upper platen 50 is heated. When the handle 44 is pulled forwardly, the heated upper platen 50 moves down onto the transfer and applies both heat and pressure on the transfer and this causes a transfer of the printing and/or design from the transfer to the work piece. The apparatus for heating the upper platen 50 is not a part of the present invention and can be conventional. A portion of the electrical cord leading from a source of electricity to the heating elements in the upper platen 50 may be incorporated in the arch 12.

The illustrated embodiments are only examples of the present invention and, therefore, are non-limitive. It is to be understood that many changes in the particular structure, materials and features of the invention may be made without departing from the spirit and scope of the invention. Therefore, it is my intention that my patent rights not be limited by the particular embodiments that are illustrated and described herein, but rather are to be determined by the following claims, interpreted according to accepted doctrines of patent claim construction, including use of the doctrine of equivalents.

What is claimed is:

1. A heat transfer imprinting machine, comprising:
a base having spaced apart opposite sides;
a lower platen supported on and by the base;
a support arch having a top portion and opposite side portions depending from opposite side boundaries of the top portion down to lower ends which are connected to the opposite sides of the base;
an upper platen positioned vertically between the lower platen and the upper portion of the arch; and
a vertically movable push/pull member extending downwardly from a central part of the top portion of the arch and having a lower end that is attached to the upper platen, said member being movable vertically up and down to move the upper platen towards and away from the lower platen.

2. The heat transfer imprinting machine of claim 1, comprising a housing at the center of the top portion of the support arch, said push/pull member extending downwardly from said housing to a connection with the upper platen.

3. The heat transfer imprinting machine of claim 2, comprising a lever extending from the housing and movable between up and down positions for moving the push/pull member and the upper platen up and down.

4. The heat transfer imprinting machine of claim 1, wherein the base includes a center portion having base members that are spaced laterally apart from each other and laterally inwardly from the side portions of the arch, said base members engaging the lower platen and supporting it for sliding movement between a position substantially vertically below the upper platen and a position at least partially endwise of the upper platen.

5. The heat transfer imprinting machine of claim 1, wherein the base includes a cross frame member extending from one lower end of the arch over to the other lower end of the arch and at least one longitudinal frame member extending across and connected to the cross frame member.

6. The heat transfer imprinting machine of claim 5, comprising two longitudinal frame members spaced laterally apart and each extending across and being connected to the cross frame member.

7. The heat transfer imprinting machine of claim 1, wherein the top and side portions of the arch at least in part have a channel cross-sectional shape opening downwardly from the top portion and laterally inwardly from the side portions.

8. The heat transfer imprinting machine of claim 7, wherein the top and side portions of the arch include opposite side flanges and at least one strengthening rib between the side flanges and projecting from the web in the same direction as the side flanges.

9. The heat transfer imprinting machine of claim 7, wherein the top and side portions of the arch have two strengthening ribs spaced apart from each other and laterally inwardly from the side flange portions of the arch.

10. The heat transfer imprinting machine of claim 4, wherein the base members include laterally spaced apart telescopic members, each having a fixed portion connected to the base and a movable portion connected to the lower platen, said movable portion extending as a cantilever beam out from the fixed portion when the movable portion is extended.

11. The heat transfer imprinting machine of claim 6, wherein the longitudinal frame members have opposite end portions each including a support foot.

12. The heat transfer imprinting machine of claim 4, wherein the base members have opposite ends with support feet.
